(19) United States
(12) Patent Application Publication
(10) Pub. No.: US 2026/0133092 A1
(43) Pub. Date: May 14, 2026

(54) METHOD FOR VERIFYING OPERATION OF AN OPTICAL FIBER MONITORING SYSTEM

(71) Applicant: Network Integrity Systems, Inc., Hickory, NC (US)

(72) Inventors: Cary R. Murphy, Hickory, NC (US); Dave E. Cunningham, Conover, NC (US); Mark K. Bridges, Hickory, NC (US); Daniel M. Goertzen, Winnipeg (CA)

(21) Appl. No.: 18/944,991

(22) Filed: Nov. 12, 2024

(51) Int. Cl. G01M 11/00; G01M 11/02

(52) U.S. Cl. CPC G01M 11/334; G01M 11/0207

(57) ABSTRACT

In an optical fiber monitoring system which detects physical disturbance or other parameters such as temperature or strain of a fiber where a monitor signal is transmitted along the optical fiber and analyzed to detect changes which are indicative of an event, said system is able to be periodically tested by a verification system performing signal interruption by an optical switch, a method is provided for checking proper operation of the verification system by comparing before and after characteristics of a monitored signal including power, modal distribution, and/or state of polarization.

This invention relates to a method for verifying proper operation of a optical fiber monitoring method of the type comprising:
using a detection system to detect changes in a monitored optical fiber caused by one or more events on the monitored optical fiber by:
   transmitting from a source of light at a transmit location a monitor signal along the monitored optical fiber;
   receiving the monitor signal after transmission along the monitored optical fiber;
   analyzing the monitor signal after transmission along the monitored optical fiber to detect changes therein caused by the event to be monitored;
   and generating an alarm in response to said detected changes which are indicative of an event.

### BACKGROUND OF THE INVENTION

Optical fiber is used for many types of monitoring applications, including but not limited to perimeter security, network security, structural monitoring.

Typically the fiber concerned is monitored using a method which includes transmitting from a source of light at a transmit location a monitor signal along the optical fiber, receiving the monitor signal after transmission along the fiber, analyzing the monitor signal after transmission along the fiber to detect changes therein and generating an alarm in response to the detected changes.

In regard to communications networks, the monitor system is responsive to vibration, motion, or handling of the fiber which are indicative of an intrusion attempt on the fiber.

In addition, the invention herein can be used for fence and buried perimeter protection systems where a fiber is mounted on or at the item to be secured so that again the fiber is monitored for vibration or motion of the fiber caused by attempts to access or penetrate the item concerned.

Yet further, the invention herein can be used for other fibers used for monitoring forces on the fiber caused by strain or other forces that monitor bridge or building integrity. These can include stretching or compression of the fiber. In this case the monitor Is not looking for transverse vibration or movement of the fiber from an intrusion attempt or other handling but is instead looking for changes in the character of the fiber caused by the application of the forces to the fiber. Such arrangement can be used in strain gauges, building and bridge monitoring systems and the like.

Additionally, the invention herein can be used on monitoring fibers distributed throughout a so-called ‘smart city” type application. In these instances, fibers are distributed to monitor traffic patterns, weather, electrical distribution, and seismic activity.

One method for monitoring a communications network cable is to use fibers that are internal to the protected cable. This so-called “intrinsic monitoring” is shown in U.S. Pat. No. 7,706,641 issued Apr. 27, 2010 to the present applicant, the disclosure of which is incorporated herein by reference.

The optical fibers can be monitored using a variety of detection techniques including:

Modal metric, where changes in a modal power distribution in a multimode fiber are detected as shown in U.S. Pat. No. 7,092,586 issued Aug. 15, 2006 to the present applicant, the disclosure of which is incorporated herein by reference.

Attenuation, where simply an attenuation in the monitoring signal received is measured.

Optical Time Domain Reflectometer (OTDR) where reflections or localized attenuations from components of the fiber are detected. Distributed sensing (DAS/DSS/DTS):

DAS—Distributed Acoustic Sensing where vibrations and displacements cause localized shifts in the path length of the optical fiber. This is detected by a high precision optical Time Domain Reflectometer (OTDR). This OTDR is often referred to as a Phase-OTDR or φ-OTDR, and measures changes in the distance between points of Rayleigh backscatter.

DSS—Distributed Strain Sensing—where strain is measured along a fiber due to tensile or compressive displacements, compression, or cracks. Typically measured using Brillouin OTDR, transmitted light and scattered light are mixed as a heterodyne receiver. This Brillouin frequency shift is proportional to strain and temperature in the fiber.

DTS—Distributed Temperature Sensor—where temperature is measured along an optical fiber including by use of Raman OTDR. Light propagating down the fiber at two wavelengths cause Stokes and anti-Stokes light. The amplitude of light reflected back to the detector in a similar fashion to Rayleigh Backscattering in a traditional OTDR, is highly dependent on temperature. The ratio of Stokes and anti-Stokes light indicates temperature, while the round trip transit time indicates location. As with DSS, Brillouin OTDR can also be used to measure distributed temperature.

Polarization monitoring, where changes in a polarization in the signal in a single mode fiber are detected as shown in U.S. Pat. No. 7,142,737 issued Nov. 28, 2006 to the present applicant, the disclosure of which is incorporated herein by reference.

Active fiber monitoring, where monitoring signal and data signal pass on the same fibers as shown in U.S. Pat. No. 7,092,586 issued Aug. 15, 2006 to Vokey et al. and the present applicant, the disclosure of which is incorporated herein by reference.

Strain monitoring such as strain gauge where a Fiber Bragg Grating, strain gauge or DSS monitors a fiber or mechanical structure, disturbance will be stretching or compression.

Interferometry such as the Mach-Zehnder interferometers used for network and perimeter monitoring. These may be zone based, or locating by use of bidirectional differential time of flight systems.

Each of these methods of monitoring exploit a specific attribute of the fiber—be it loss, rotation of state of polarization, Rayleigh scattering, or others.

In some cases a single fiber is monitored with typically the transmission at one end and the monitoring at the other or same end. However other arrangements can be used in the present invention including for example the loop type network shown for example in U.S. Pat. No. 7,142,737 issued Nov. 28, 2006, to the present applicant, the disclosure of which is incorporated herein by reference.

Often these systems are placed into service, but continued viability and availability should be verified, as is mandated in some security applications such as Alarmed Carrier PDS per CNSSI 7003 Protected Distribution Systems (PDS). The method provided herein can be used with any of the above monitoring systems

One commercially available existing arrangement for this function is performed using a simple optical switch or shutter which blocks the signal and confirms detection by the monitoring system. This test is implemented by passing the monitoring fiber in a secure network through an optical shutter that blocks or redirects transmission of the light from the fiber. At the appropriate time, scheduled, spontaneous, or random, the optical shutter opens the circuit, causing the monitoring equipment to register an alarm.

### SUMMARY OF THE INVENTION

According to a first aspect of the invention there is provided a method for operation of an optical fiber monitoring system comprising:
using a detection system to detect changes in a monitored optical fiber caused by one or more events on the monitored optical fiber by:
   transmitting from a source of light at a transmit location a monitor signal along the monitored optical fiber;
   receiving the monitor signal after transmission along the monitored optical fiber;
   analyzing the monitor signal after transmission along the monitored optical fiber to detect changes therein caused by the event to be monitored;
   and generating an alarm in response to said detected changes which are indicative of an event;
and verifying operation of the optical fiber monitoring system by:
   causing an interruption of the transmission of the monitor signal;
   analyzing the monitoring signal after transmission along the monitored optical fiber and comparing the motoring signal after transmission along the monitored optical fiber prior to and subsequent to the interruption to detect changes therein caused by changes in the monitored optical fiber; and
in the event that changes therein caused by changes in the monitored optical fiber are detected, actuating a warning that the optical fiber monitoring system is not verified.

According to a second aspect of the invention there is provided a method for operation of an optical fiber monitoring system comprising:
using a detection system to detect changes in a monitored optical fiber caused by one or more events on the monitored optical fiber by:
   transmitting from a source of light at a transmit location a monitor signal along the monitored optical fiber;
   receiving the monitor signal after transmission along the monitored optical fiber;
   analyzing the monitor signal after transmission along the monitored optical fiber to detect changes therein caused by the event to be monitored;
   and generating an alarm in response to said detected changes which are indicative of an event;
and verifying operation of the optical fiber monitoring system by:
   obtaining first data relating to optical power transmitted when the monitored optical fiber is unplugged from the system;
   causing an interruption of the transmission of the monitor signal;
   during the interruption of the transmission of the monitor signal obtaining second data relating to optical power transmitted when the optical signal is interrupted;
   and in the event that differences between the first and second data caused by changes in the monitored optical fiber are detected, actuating the warning that the optical fiber monitoring system is not verified.

In accordance with one important feature of this invention which can be used with any other feature presented herein, the warning is indicative that either the optical fiber monitoring system is not properly operating or the monitored optical fiber has undergone change or replacement. That is the method herein avoids the situation where a knowledgeable intruder utilizes the time period where monitoring is turned off by the disconnection of the signal to modify the fiber to their own intentions either by attaching something to the fiber, or by changing its path or by totally replacing the fiber with a new component.

In accordance with one important feature of this invention which can be used with any other feature presented herein, the changes in the monitored optical fiber are caused by changes in the monitored optical fiber and not by detection of changes which are indicative of an event. That is the method herein is limited to looking for changes in the signals which are indicative of the modification of the fiber itself and not to the events which are intended to be monitored. This is enabled by using a combination of a separate break-detect algorithm for detection of this test condition as well as observing critical timing of the method steps. In a typical installation, rather than relying on the normal detection algorithms for detection of the test, it is preferred, but not required, that only the fiber break detect algorithm is used for the test. Additionally, the time of the test is known, therefore the fiber break detect and other algorithms will be known to not be the test result at any other time. If the fiber break detect alarms other than during an actual test, it will be known to be a fiber monitor alarm rather than system test alarm.

In accordance with one important feature of this invention which can be used with any other feature presented herein, the changes in the monitored optical fiber are caused by:
A change in path;
A replacement fiber;
An addition of a monitoring tap;

In accordance with one important feature of this invention which can be used with any other feature presented herein, when a requirement for verifying operation is indicated, a recording is made of the monitoring signal after transmission along the monitored optical fiber and the interruption is caused after the recording is made. That is the triggering of the requirement for the verification, which can be triggered in many different ways as set out below, first activates a recording system to ensure that the pre-disconnection data is available for the comparison with the post-disconnection data.

In accordance with an alternative important feature of this invention which can be used with any other feature presented herein, where a recording is made continually of the monitoring signal after transmission along the monitored optical fiber the recording of the signal prior to the interruption is compared with the recording after the interruption after the interruption has occurred.

In accordance with one important feature of this invention which can be used with any other feature presented herein, a requirement for verifying operation is caused or triggered by one or more of:
a manual trigger is provided for causing operation of the fiber disturbance actuator where the manual trigger causes the operation immediately or after a predetermined or random time or time window.
autonomously; where the operation can be scheduled or random in occurrence;
a self-initiate test at a scheduled or random time.;

In accordance with one important feature of this invention which can be used with any other feature presented herein, the changes in the monitored optical fiber caused by changes in the monitored optical fiber are monitored by the analysis of the same optical property as the changes therein caused by the event to be monitored. That is basically the same monitoring system is used of the examples set out above and the system monitors the same characteristics or properties of the fiber to detect the changes pre and post interruption data. Alternatively the monitoring system may use the same signals but use them to obtain data relating to a different characteristic of the signals.

In accordance with an alternative important feature of this invention which can be used with any other feature presented herein, the changes in the monitored optical fiber caused by changes in the monitored optical fiber are monitored by the analysis of a different optical property than the changes therein caused by the event to be monitored. The monitoring system may in fact use alternative monitoring signals in the analysis and determine different characteristics indicative of the modification to the fiber as opposed to the monitored events.

In accordance with one important feature of this invention which can be used with any other feature presented herein, the optical property used to detect changes in the monitored optical fiber comprises one or more of the following:
optical power;
modal distribution;
state of polarization;
relative power between multiple detection receivers. That is, some detection methods require more than one detector within the receiver, for example a full polarization analyzer would require a minimum of three. There are mathematical processes to reduce these multiple signals down to one signal, however it is possible that the relative signal strengths change without impacting the final signal. For example, changing fibers might cause a circular polarizer to go up in power while a linear polarizer goes down. The next result would suggest no change, but an independent analysis of the detector signals will detect a fiber concern or alarm.
change in the trajectory of the measured attributes. That is, it is common for the monitor signal to be slightly in motion at all times, due in part to the constant subtle changes in ambient environment such as temperature as well as ambient vibrations. This change will affect each fiber a little differently, and with the same disturbance one fiber will cause the signal to go up while another fiber signal might go down. As the absolute power of the change has not changed, this might not be detected. Monitoring the internal temperature for the direction of this drift, and identifying a change in direction before and after a test is reason for concern or sounding an alarm.
change in the quality of the measured attributes. That is, this moving signal will have a quality associated with it, such as peak-peak variation over a specific time, density of motion over said time, and others. If the fiber noise were to get quieter after a test, it might indicate that a new fiber that is in a different environment might have been substituted, and is cause for concern or alarm.
crest factor of the measured attributes. That is the crest factor is defined as peak amplitude signal divided by RMS (root mean square) of the signal. This is the relationship of the maximum during a specific time window as compared to the average. An abrupt change in this after a test might indicate that a new fiber that is in a different environment might have been substituted, and is cause for concern or alarm.
a frequency analysis of the signal. A frequency domain detection algorithm, such as SFD (Smart Filter Detection) used by Network Integrity Systems, Inc, measures a spectral signature of the ambient disturbances of a fiber installation. A sudden change in that spectral signature after a test might indicate a change in fiber to one in a different ambient environment, and is cause for concern or alarm.
a frequency analysis of the drift of the signal. As explained above, the sensing system might depend upon a spectral signature of the ambient signal, and that signal is in constant drift due to cable technology as well as ambient. This drift will have a measurable frequency component that if changes due to a test might indicate that a new fiber that is in a different environment might have been substituted, and is cause for concern or alarm.

In some arrangements of fiber to be monitored, only one of the above may be sufficient to detect the changes indicative of the modification of the fiber itself. In other arrangements multiple ones of the above may be necessary. This depends on the type of fiber and the configurations of the fiber in use.

Thus there is provided a method for verifying operation of a test device which periodically checks proper operation of the optical fiber verification system by: monitoring and recording the output signal of the monitored optical fiber; periodically operating the fiber disturbance actuator such as a switch or shutter; monitor and record the output signal of the monitored optical fiber after the test has returned the system to normal operation, analyzing the change in system signal parameters, as discussed above, in order to detect changes therein caused by said fiber disturbance actuator. In the event that measured changes due to actuation of said fiber disturbance actuator are in excess of expected values, issue a warning that the intrusion detection system is not properly operating or that the monitored fiber might have been altered, replaced, or otherwise compromised.

The test device satisfies a number of applications:

Under command from a communicating device such as a data network or serial port, the fiber disturbance actuator can be instructed to activate. When this activation is detected by the monitoring device, satisfaction of periodic health check of the monitoring system is satisfied. This test may be in satisfaction of a formal standard, or as good practice as defined by the user.

The fiber disturbance actuator may have a manual trigger such as a push button, causing a test to initiate. This test might occur immediately or after a predetermined or random time, adding confidence to the test.

The fiber disturbance actuator and the control system operating the actuator can in some cases be configured to initiate tests autonomously; where this might be scheduled or random in occurrence.

The arrangement can perform periodic connectivity test to confirm the intended fiber is being monitored.

As cited above in U.S. Pat. No. 7,706,641, fiber security products, such as the Interceptor (trademark) product from Network Integrity Systems perform a fiber monitoring function that is zone based. Rather than pinpoint a location, these devices utilize a loop of fiber, and monitor the entire continuous loop as one zone. The arrangement herein is applicable for zone use as well. The fiber disturbance function of the fiber disturbance actuator acts similarly to a location determining product.

This invention assures security of the test device by monitoring and recording optical and electrical properties before and after the test, and performing analysis to determine if the monitored fiber has been altered during the “blind” period, that is the time when the shutter is actuated and therefor the monitoring system cannot monitor the fiber.

In accordance with one important feature of this invention which can be used with any other feature presented herein, further information concerning the potential changes to the fiber being monitored including obtaining first data relating to optical power transmitted when the monitored optical fiber is unplugged from the system, during the interruption of the transmission of the monitor signal obtaining second data relating to optical power transmitted when the optical signal is interrupted; and in the event that significant differences between the first and second data are detected, actuating the warning that the optical fiber monitoring system is not verified. This data can supplement the above systems and can provide information even during the “blind” period. That is the attenuation of the signals during the interrupted period are in some cases different from those when the fiber concerned is fully unplugged from the system and if this property is monitored during the interruption period, any changes can be indicative of a change to the fiber rather than just the expected attenuation caused by the interruption. Due to the fact that an optical shutter introduces less optical loss than unplugging a fiber, the monitored data can relate to the optical power level and sense a fiber being unplugged during the open shutter condition. Additionally, the rise and fall slope of the power drop and return may be different for an optical shutter as compared to an unplugging of a fiber, and this might indicate that a new fiber might have been substituted, and is cause for concern or alarm.

### BRIEF DESCRIPTION OF THE DRAWINGS

FIG. 1 is a schematic layout illustration of a system for monitoring an optical fiber according to the present invention.

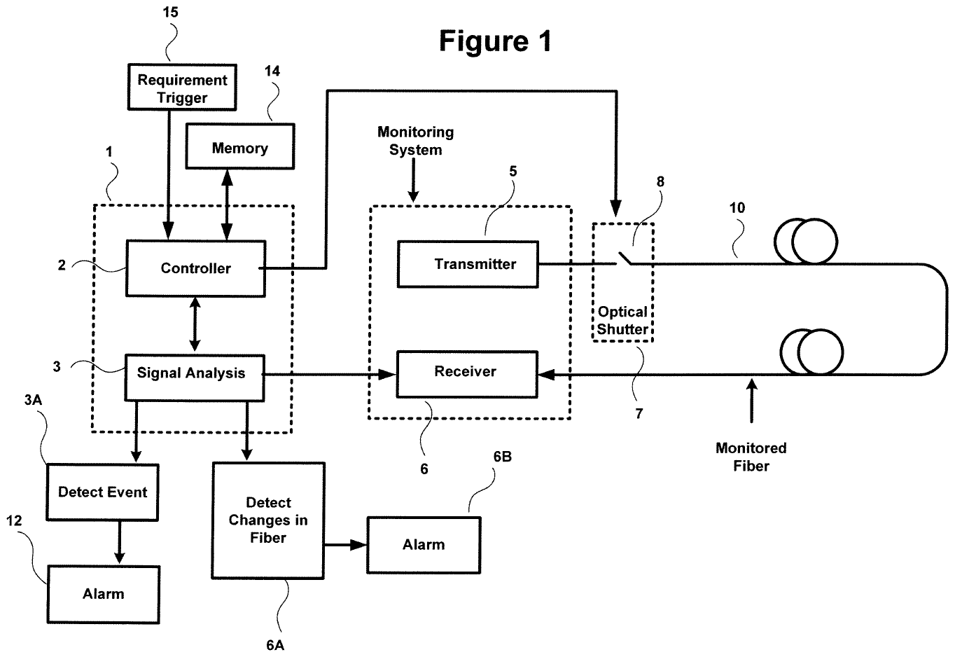

FIG. 2 is a flow chart illustrating the steps of the method of FIG. 1 where the triggering of a request for test initiates the recording of data of the characteristics or properties of the fiber pre interruption for comparison with the same data post interruption.

FIG. 3 is a similar flow chart illustrating the steps of the method of FIG. 1 where the data of the characteristics or properties of the fiber is continually recorded pre interruption and post interruption for comparison.

### DETAILED DESCRIPTION

A typical optical fiber monitoring system includes a control and analysis system 1 in constructed of a controller 2 and a signal analysis section 3. The controller 2, upon determination that a test is required acts to instruct signal analysis section 3 to gather initial data from receiver 6 relating to characteristics or properties of the fiber which are indicative of a modification to the fiber. The receiver 6, upon collecting initial data indicates to the controller 2 that a test may be initiated. The controller 2 initiates the test by opening optical shutter 8 in verification system 7 for a prescribed period of time. During that period, the receiver 6 transmits data to the signal analysis system 3 for evaluation. After prescribed time, the controller 2 disables the optical shutter 8 and causes the signal analysis 3 includes a section 6A to gather post-test data from the receiver 6. The signal analysis portion 3 evaluates the data and initiates alarm 6B as prescribed.

The test method is used with an optical fiber monitoring system which includes the detection system 3, 6 to detect changes in a monitored optical fiber 10 caused by one or more events on the monitored optical fiber. Thus the system includes a transmitter 5 for transmitting from a source of light at a transmit location a monitor signal along the monitored optical fiber 10. The system includes a receiver 6 for receiving the monitor signal after transmission along the monitored optical fiber, the signal analysis 3 including a detector 3A for analyzing the monitor signal after transmission along the monitored optical fiber to detect changes therein caused by the event to be monitored and an alarm system 12 for generating an alarm in response to said detected changes which are indicative of an event.

Operation of this monitoring system is verified using the system herein by using the optical switch 8 to cause an interruption of the transmission of the monitor signal, by analyzing the monitoring signal after transmission along the monitored optical fiber and comparing the motoring signal after transmission along the monitored optical fiber prior to and subsequent to the interruption to detect changes therein caused by changes in the monitored optical fiber; and, in the event that changes therein caused by changes in the monitored optical fiber are detected, actuating a warning that the optical fiber monitoring system is not verified.

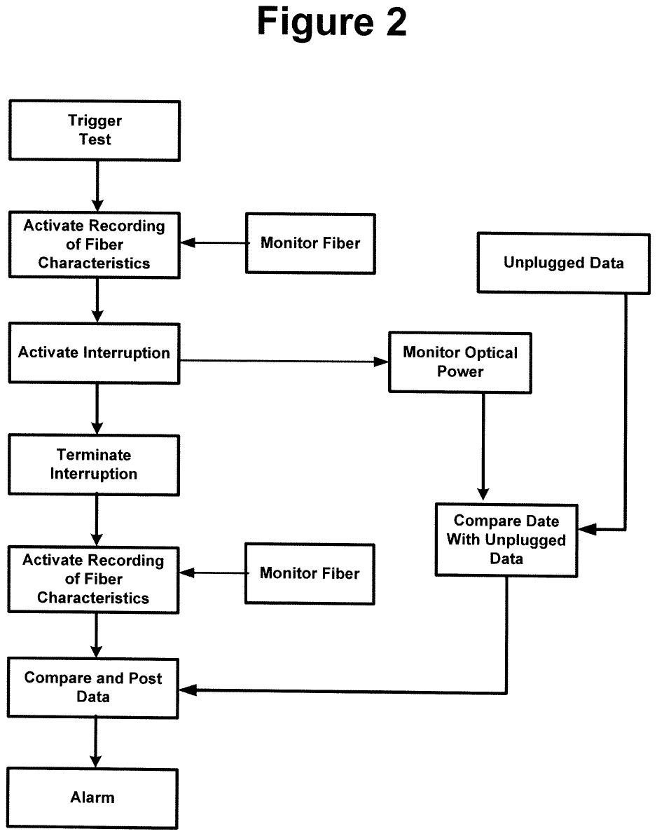

As shown in the method set out in FIG. 2, when a requirement for said verifying operation is indicated, a recording in a memory 14 is made of the monitoring signal after transmission along the monitored optical fiber and the interruption is caused after the recording is made.

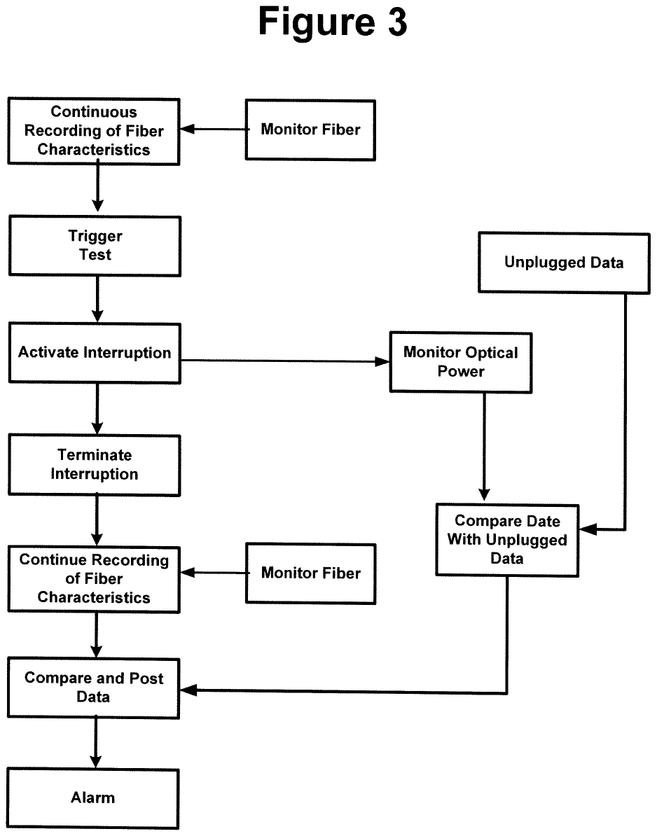

As shown in FIG. 3, a recording is made continually of the monitoring signal after transmission along the monitored optical fiber the recording of the signal prior to the interruption is compared with the recording after the interruption after the interruption has occurred.

The activation of the requirement for verifying operation as shown at 15 can be caused by one or more of:
a manual trigger is provided for causing operation of the fiber disturbance actuator where the manual trigger causes the operation immediately or after a predetermined or random time.
autonomously; where the operation can be scheduled or random in occurrence;
a self-initiate test at a scheduled or random time.

As shown in FIG. 2, the above data is supplemented by further information obtained during the period when the disconnect switch is activated. Thus during this period, the system acts for obtaining first data relating to optical power transmitted when the monitored optical fiber is unplugged from the system. Also, during the interruption of the transmission of the monitor signal obtaining second data relating to optical power transmitted when the optical signal is interrupted. In the event that differences between the first and second data are detected, the warning that the optical fiber monitoring system is not verified is provided to determine if an alarm should be emitted.

1. A method for operation of an optical fiber monitoring system comprising:
using a detection system to detect changes in a monitored optical fiber caused by one or more events on the monitored optical fiber by:
transmitting from a source of light at a transmit location a monitor signal along the monitored optical fiber;
receiving the monitor signal after transmission along the monitored optical fiber;
analyzing the monitor signal after transmission along the monitored optical fiber to detect changes therein caused by the event to be monitored;
and generating an alarm in response to said detected changes which are indicative of an event;
and verifying operation of the optical fiber monitoring system by:
causing an interruption of the transmission of the monitor signal;
analyzing the monitoring signal after transmission along the monitored optical fiber and comparing the monitoring signal after transmission along the monitored optical fiber prior to and subsequent to the interruption to detect changes therein caused by changes in the monitored optical fiber; and
in the event that changes therein caused by changes in the monitored optical fiber are detected, actuating a warning that the optical fiber monitoring system is not verified.

2. The method according to claim 1 wherein the warning is indicative that either the optical fiber monitoring system is not properly operating or the monitored optical fiber has undergone change or replacement.

3. The method according to claim 1 wherein said changes in the monitored optical fiber are caused by changes in the monitored optical fiber and not by detection of changes which are indicative of an event.

4. The method according to claim 3 wherein said changes in the monitored optical fiber are caused by:
A change in path
A replacement fiber
An addition of a monitoring tap

5. The method according to claim 1 wherein, when a requirement for said verifying operation is indicated, a recording is made of the monitoring signal after transmission along the monitored optical fiber and the interruption is caused after the recording is made.

6. The method according to claim 1 wherein a recording is made continually of the monitoring signal after transmission along the monitored optical fiber the recording of the signal prior to the interruption is compared with the recording after the interruption after the interruption has occurred.

7. The method according to claim 1 wherein a requirement for verifying operation is caused by one or more of:
a manual trigger is provided for causing operation of the fiber disturbance actuator where the manual trigger causes the operation immediately or after a predetermined or random time.
autonomously; where the operation can be scheduled or random in occurrence;
a self-initiate test at a scheduled or random time.

8. The method according to claim 1 wherein the changes in the monitored optical fiber caused by changes in the monitored optical fiber are monitored by the analysis of the same optical property as the changes therein caused by the event to be monitored.

9. The method according to claim 1 wherein the changes in the monitored optical fiber caused by changes in the monitored optical fiber are monitored by the analysis of a different optical property as the changes therein caused by the event to be monitored.

10. The method according to claim 8 wherein the optical property used to detect changes in the monitored optical fiber comprises one or more of the following:
optical power;
modal distribution;
state of polarization;
relative power between multiple detection receivers;
change in the trajectory of the measured attributes;
change in the quality of the measured attributes;
crest factor of the measured attributes;
a frequency analysis of the signal;
a frequency analysis of the drift of the signal;

11. The method according to claim 1 including obtaining first data relating to optical power transmitted when the monitored optical fiber is unplugged from the system, during the interruption of the transmission of the monitor signal obtaining second data relating to optical power transmitted when the optical signal is interrupted; and in the event that differences between the first and second data are detected, actuating the warning that the optical fiber monitoring system is not verified.

12. The method according to claim 11 wherein the data relates to the optical power level.

13. The method according to claim 11 wherein the data relates to the optical power level rise and fall time.

14. A method for operation of an optical fiber monitoring system comprising:
using a detection system to detect changes in a monitored optical fiber caused by one or more events on the monitored optical fiber by:
transmitting from a source of light at a transmit location a monitor signal along the monitored optical fiber;
receiving the monitor signal after transmission along the monitored optical fiber;
analyzing the monitor signal after transmission along the monitored optical fiber to detect changes therein caused by the event to be monitored;
and generating an alarm in response to said detected changes which are indicative of an event;
and verifying operation of the optical fiber monitoring system by:
causing an interruption of the transmission of the monitor signal;
obtaining first data relating to optical power transmitted when the monitored optical fiber is unplugged from the system;
during the interruption of the transmission of the monitor signal obtaining second data relating to optical power transmitted when the optical signal is interrupted;
and in the event that differences between the first and second data caused by changes in the monitored optical fiber are detected, actuating the warning that the optical fiber monitoring system is not verified.

15. The method according to claim 14 wherein the data relates to the optical power level.

16. The method according to claim 14 wherein the data relates to the optical power level rise and fall time.

17. The method according to claim 14 wherein a requirement for verifying operation is caused by one or more of:
a manual trigger is provided for causing operation of the fiber disturbance actuator where the manual trigger causes the operation immediately or after a predetermined or random time.
autonomously; where the operation can be scheduled or random in occurrence;
a self-initiate test at a scheduled or random time.
